(19) United States
(12) Patent Application Publication
(10) Pub. No.: US 2014/0132206 A1
(43) Pub. Date: May 15, 2014

(54) Portable Battery Charger with Inductive Charging

(71) Applicant: ECOSOL TECHNOLOGIES INC., Ottawa (CA)

(72) Inventor: Zuohang Zhu, Ottawa (CA)

(73) Assignee: ECOSOL TECHNOLOGIES INC., Ottawa (CA)

(21) Appl. No.: 13/674,585

(22) Filed: Nov. 12, 2012

(51) Int. Cl. H02J 7/00

(52) U.S. Cl. 320/108; 320/137

(57) ABSTRACT

A portable battery charger with inductive charging has a housing, an output inductive coil beneath the surface of the housing to transmit power to a portable device also having a coil therein, and a battery within the housing connected to the output coil, wherein the output coil operates at the battery voltage and transmits power from the battery to the portable device. The charger may also have an input inductive coil beneath the surface of the housing to receive power from a source, and transmit the power to the battery, and the output coil and the input coil may be the same coil. A method of charging the battery of a portable device comprises the steps of aligning the input coil of a portable device adjacent to with an output coil of a charger using magnets positioned near the respective coils, and inductively charging the device battery without connecting the device to the charger.

### FIELD OF THE INVENTION

The invention relates to battery chargers having inductive charging capability for recharging portable devices.

### BACKGROUND

Since their early development portable electronic devices like cell phones have used AC/DC adapters to charge their batteries from household AC power. More and more, USB connections are also used to charge portable devices using a DC current of approximately 5V, as well the USB can be used to exchange data between the USB source and the portable device. Especially convenient is a portable charger containing a battery, which can be charged from an AC or USB source and then carried along for later charging of a device when away from the source.

This charging has required a connector, in order to positively connect the device with the charger, so as to transfer energy. Connectors have little to no loss in transmission, however they are subject to damage and wear and tear, as they are composed of movable parts. Further, connectors are proprietary and, although common within a manufacturer's line, are not easily used across different manufacturers of devices. Considering a universal charger, if the correct adapter plug is not available then the charger will be useless.

Recently, portable devices are available with inductive coils therein to charge the battery. The inductive coil does not need a positive connection to the charger, rather must only be within close proximity, such as laying on top. Further, due to new emerging standards inductive charging is not hampered with the compatibility issues of connectors between manufacturers.

### SUMMARY OF THE INVENTION

Disclosed is a portable battery charger with inductive charging, comprising a housing, an output inductive coil beneath the surface of the housing to transmit power to a portable device also having a coil therein, and a battery within the housing having a battery voltage and connected to the output inductive coil wherein the output inductive coil operates at the battery voltage and transmits power from the battery to the portable device. In one embodiment the charger further comprises an input inductive coil beneath the surface of the housing to receive power from a source, and transmit the power to the battery. The output inductive coil and the input inductive coil may be the same coil.

The charger may further comprise a switch to select output and input functions of the coil, and/or a wireless charger transmitter connected to the output coil for communicating with the portable device. In one embodiment the communicating comprises a quantity of power to send, and a transmission frequency.

In an embodiment, the charger further comprises a wireless charger receiver connected to the input coil for communicating with the source, and the communicating comprises a quantity of power to send, and a transmission frequency. In an embodiment, both the input coil and output coil operate simultaneously.

Further, the charger further comprises a magnet near the coil for aligning the output coil with the portable device's coil, or an alignment indicator and an alignment sensor, wherein the alignment sensor determines the efficiency of the power transmission and provides information on the alignment of the output coil and the device coil to a user by means of the alignment indicator.

Also disclosed is a method of charging a portable device, comprising the steps of aligning the input coil of a portable device with an output coil of a charger using magnets positioned near the coils, and commencing inductive charging between devices. The method may further comprise the step of communicating with the portable device for regulating power transmission.

Described is a method of charging a portable device on a charger, comprising the steps of commencing the inductive charging between devices, determining the efficiency of the charging, comparing the efficiency to a maximum efficiency, providing feedback through an alignment indicator; and adjusting the position of the portable device on the charger. The method may further comprise the step of communicating with the portable device for regulating power transmission.

### DESCRIPTION OF FIGURES

FIG. 1 is a perspective exploded view of the charger; and

FIG. 2 is a system function diagram of the portable battery charger.

### DETAILED DESCRIPTION

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

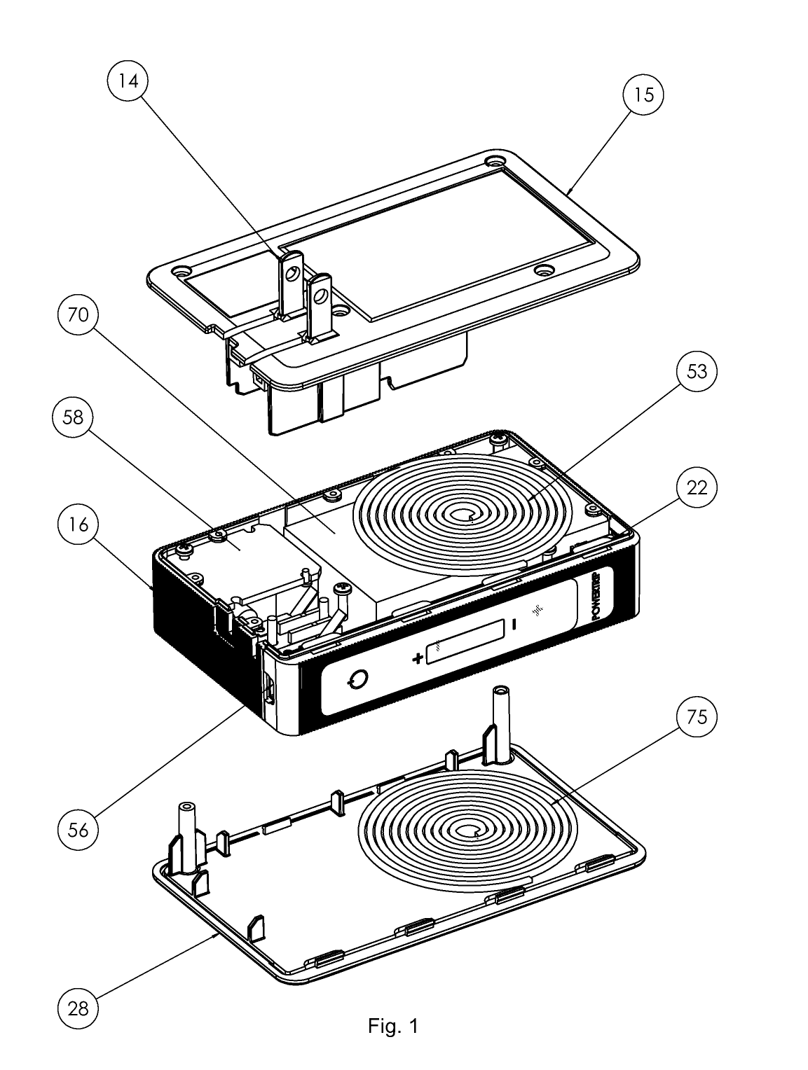

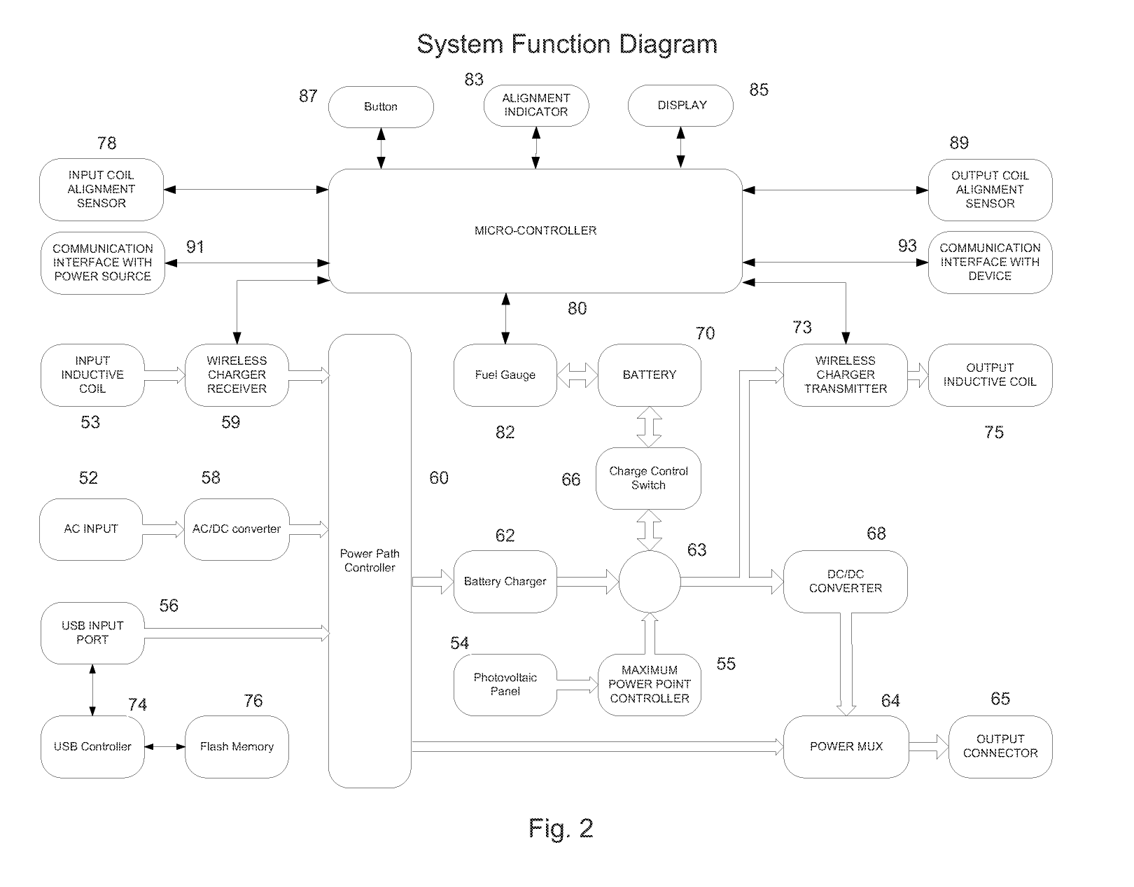

With reference to FIG. 1, both top housing 28 and bottom housing 12 are exploded showing the interior of the charger 2. The main features of the interior are the battery 70, the AC input prongs 14, the USB input connector 56, a AC/DC converter 58, input inductive coil 53, output inductive coil 75, and a PCB assembly 22 which includes a microcontroller 80, battery charging and protection circuits, battery fuel gauge, output DC/DC converter, wireless power transmitter 73 and wireless power receiver 59, shown in FIG. 2. The battery charger 2 also has an output connector 65, in one embodiment in the form of a USB connector, however one skilled in the art would appreciate that one charger may have several outputs, possibly each of a different format. If the voltage requirements are the same for each output, the outputs can be set up in parallel. If the outputs voltages are different, then each output will have its own DC/DC converter to regulate the output voltage for that output. While USB v.1, 2 and 3 present a useful standard that may be used in one embodiment, other connectors may be used in other embodiments, the connectors known to one skilled in the art, for example, FireWire™ 400 and 800 and eSATA™, and will be referred to inclusively in the specification as USB. The acronym “USB” in the specification refers to any DC source.

With reference to FIG. 2, the portable battery charger has four input sources, an AC power input 52, an input inductive coil 53, a USB input 56, and a photovoltaic (PV) panel 54. The AC input 52 receives power from a household socket, for example at 120V alternating current (AC) power, and this is converted to direct current (DC) power through the AC/DC power conversion module 58. DC power is provided in this way to the power path controller 60. DC power may also be received from the USB input 56, which receives standard USB power and voltage when connected to a USB source, which voltage is 5V in some embodiments. The input inductive coil 53 may receive a current from an inductive power source external to the charger, wherein the power is transferred to the wireless charger receiver 59 which outputs the received power into the power path controller 60. The wireless charger receiver 59 is a controller for communicating with the power source, and sends a signal to the power source to request a certain power input to the charger. The amount of requested power input is often a standard amount, or depends on the needs of the charger; however it may be variable and tailored to the output range of the power source. The wireless power receive 59 also includes a rectifier and a voltage regulation circuit in order to output a regulated DC output voltage. The USB input 56 may be any DC source, not limited to USB, and may include Firewire™ and other sources. These three DC power inputs, the AC input 52 converted to DC by the AC/DC converter 58 (with a voltage of 5V in some embodiments), the input inductive coil 53 which receives and outputs DC power, and the DC power received from the USB input 56, are inputs to the power path controller 60. Therefore, the portable charger receives 5V input from the USB input 56, 5V from the wireless charger receiver 59 (in some embodiments), and 5V input from the AC/DC converter 58, and can directly output these voltages, without further conversion, through the power path controller 60 and power MUX 64 to the output connector 65. The power path controller 60 can then transmit the power received to i) the battery charger 62 to charge the battery, ii) through the battery charger 62 and junction 63 to the wireless charger transmitter 73 to the output inductive coil 75, iii) through the battery charger 62 and junction 63 to the DC/DC converter 68 to upconvert from a battery voltage to a system voltage, and through the power multiplexer (MUX) 64, or iv) directly to the power MUX 64, for output through the output power connector 65, at the same voltage it was received, with no need for the inefficiencies of power conversion.

If there is a load, such as a portable device, connected to the output power connector 65 or output inductive coil 75, then the priority of the power path controller 60 is to charge the load, so all or some of the power (if there is power left over) from the input sources 52, 53 and/or 56, is sent to the output power connector 65 by means of the power MUX 64, or directly to the output inductive coil 75, depending on whether the device is connected to the output power connector 65 or output inductive coil 75. Separate devices may be attached to both the output power connector 65 and the output inductive coil 75 at the same time, and the charger will charge both. However, this situation will produce a greater draw on the system and it is more likely that the battery 70 will need to supplement the outgoing power (described below). If input power remains after the necessary power is delivered to the load, the remaining input power is diverted by the power path controller 60 to the battery charger 62 to charge the battery 70. The charger 62 sends an interrupt to the microcontroller 80 with which it is connected, and the microcontroller 80 verifies the charge of the battery. If the battery 70 is not charged, the charge control switch 66 is turned on and current enters the battery. The load simultaneously receives the maximum amount of current it can receive. As the load is charged, the current accepted by the device will diminish and the current diverted to the battery grows.

If the load demands further power to that received from the input sources 52, 53 and/or 56, then the output power can be supplemented by the battery 70. If the device is connected to the output connector 65, and the load requires a greater current, the power MUX 64 gives an overcurrent signal to the microcontroller 80, which signals the DC/DC converter to output battery power. If the battery is empty, despite the overcurrent signal the microcontroller 80 will check the battery power. If it determines there is no power available in the battery it will not to open the DC/DC converter 68 to provide battery power. Once power is provided by the DC/DC converter 68, current flows from the charge control switch 66 through the DC/DC converter 68, power MUX 64 to the output connector 65. As the device is charged, the current demand will become less and the battery output will also be diminished, as the battery 70 conserves energy. Throughout the charging a constant amount is drawn from the input sources 52, 56. The power MUX 64 can be set for multiple inputs simultaneously, or individual inputs. The output power can be further supplemented by the PV panel 54 which provides additional power to the junction 63, for output by means of the DC/DC converter. If the load is on the output connector 65 and demands an output power that is greater than can be delivered by the input sources 52, 53 and 56 and the battery 70 has no power, the power MUX 64 will operate in overcurrent mode with a lower voltage. The addition of power by the battery 70 is typically the case where the input source 56 is USB 2.0 input or input inductive coil 53, where the input source 56, 53 does not provide sufficient power for the load (not shown), which power is then supplemented by the battery 70 to charge the load as quickly as possible.

If the device is connected with the output inductive coil 75, and the load requires a greater current, then the output current is supplemented directly from the battery 70 through the junction 63. In one embodiment, the wireless charger transmitter 73 and output inductive coil are at the battery voltage (3-4.2V), avoiding the need for up-conversion to a standard voltage such as 5V, increasing efficiency. The output induction coil would therefore operate at the battery voltage as well. At battery voltage, there is no extra power loss, however the output power maybe lower due to lower input voltage (3-4.2V). As an example, the inductive transmission efficiency stands at approximately 72%. If the battery voltage is regulated up to 5V for the coil, for example, the process of regulating the voltage reduces the efficiency by a further 10%. When transmitting the battery power directly to the output coil 75, using battery voltage, without the need for a booster converter or regulator converter, there is no such loss and therefore the overall efficiency is improved.

In another embodiment, there is a DC/DC converter between the junction 63 and the wireless charger transmitter, so that the wireless charger transmitter 73 and the output inductive coil 75 operate at 5V instead of the battery voltage. This may be to comply with standards such as the Qi™ standard that is currently in development. As there may be a power limit of the wireless charger transmitter, the power flowing to the output coil 75 can be limited on that basis.

If the AC/DC converter 58 has an overcurrent condition, then voltage is decreased to a threshold (4.7V in some embodiments) forming an overcurrent signal, and the charger 62 knows from the overcurrent signal to decrease its current draw so output voltage from the power source doesn't further decrease.

If there is no input source 52, 53 or 56, and a load is connected to output connector 65, once the button 87 is pushed, the microcontroller 80 checks the battery. If there is available power in the battery, the microcontroller 80 signals the DC/DC converter 68 to open and the current flows from the battery through the DC/DC converter 68 (where the voltage is increased to 5V) and out the output connector 65.

If there is no input source, and a load is connected to output inductive coil 75, once signalled to, the microcontroller will check the battery 70 energy level. The charge control switch 66 is turned on if there is enough energy in battery and the current flows from battery 70 to the wireless power transmitter 73 and to output inductive coil 75.

If there is no load on the output power connector 65, input power is instead sent by the power path controller 60 directly to the battery charger 62. The charge control switch 66 is informed by the microcontroller 80 whether the battery 70 can receive power, which depends on whether the battery 70 is fully charged, or damaged, for example. If the microcontroller indicates the battery 70 can receive further power, then the charge control switch 66 sends power to the battery pack to charge it. The charger 62 determines the charging current and the battery 70 condition. If the battery is full charged and cannot receive further power, the power is sent to the DC/DC converter 68, and then on the power MUX and the output power connector 65 for output, if a load such as a portable device (not shown) is connected. In no load is connected, the charger 62 provides a trickle charge (50 mA-100 mA) to the battery to maintain it.

If the battery 70 is damaged, or old, this will typically result in a lower capacity and a high internal resistance for the battery 70, and so considering the voltage drop on the internal resistance more power is needed the more aged or damaged the battery. When the microcontroller 80 determines that a battery 70 is damaged, it may use a trickle charge only to charge it, as damage can reduce the input current of the battery in addition to its capacity.

When the power is sent from the battery charger 62 or the power point controller 60 into the junction 63, the microcontroller determines if there is a load on either the output power connector 65 or the output inductive coil 75, or both. If the output power connector 65 is connected to a load (not shown) which is drawing power, the microcontroller commands the junction 63 to route the power through the DC/DC converter 68, which adjusts the varying voltage of the battery 70 to a fixed output voltage for the load (not shown) connected to the output power connector 65. The power having adjusted voltage is then directed to the power MUX which outputs it through the output power connector 65. If a load is connected on the output inductive coil 75, the microcontroller commands the junction 63 to route power through the wireless charger transmitter 73 and through the output inductive coil 75 at battery voltage.

If the battery 70 cannot receive a charge, as it is fully charged, and there is no load connected to the output connector 65, then no power is drawn from the input sources. The microcontroller 80 turns off the charger 62 and there is no power path to the battery, and the microcontroller 80 will turn off the AC/DC converter 58 in order to save energy from AC line. In one embodiment the PV panel 54 is constantly on so as to provide a trickle charge to the battery 70. If the battery cannot receive the charge from the PV panel 54 the excess energy is dissipated as heat.

There is an input inductive coil 53 and an output inductive coil 75, which are positioned on opposite sides of the housing, in one embodiment. In another embodiment, the input and output inductive coils 53, 75 use a single physical coil within the device, on one side of the housing, and the coil may be switched between receiving and transmitting functions. When a device is placed on the coil, the device is scanned by the coil to determine whether the receive or transmit capability should be used. Alternatively, the user can decide whether the charger will receive or transmit energy. The use of one coil for both receive and transmit functions has the benefit of requiring fewer parts so that it is cheaper and simpler. However, this configuration would not meet current Qi™ standard compliance.

In order for the induction charging to work properly, the coils must be aligned with each other. In one embodiment, magnets are present in the center of each of the coils on the device and the charger, so that the magnetic attraction is strongest when the coils are coaxial, this being the position to which the magnets are drawn. In an alternative embodiment, if the charger is being charged by means of an external source interfacing with the input coil 53, the input coil alignment sensor 78 determines the maximum efficiency and hence the optimal position, and provides feedback to the user by means of an alignment indicator 83. The input coil 53 also permits communication between external source and the charger through the input coil communication interface 91. Similarly, using the output inductive coil 75 to charge a portable device, the output coil alignment sensor 89 will determine position for maximum current throughput and provide feedback to the user by means of the alignment indicator 83. The alignment indicator 83 may consist of a light that changes colors from red indicating no connection, through yellow showing there is some connection but is not yet optimized, changing to green when the ideal position for maximum efficiency is found. This position is generally found where the two coils that are transferring energy are coaxial. The output coil 75 also permits communication between external source and the charger through the input coil communication interface 93.

Communication through the inductive coil on the input side is possible between the input inductive coil 53 and the inductive coil on a charging device (not shown) providing input power to the charger. Signals may be transmitted from the wireless charger receiver 59 to the transmitter of the charging device (not shown), where the receiver 59 asks the transmitter (not shown) the quantity of power to send. In order to regulate power transmission, the receiver 59 must communicate with the transmitter (not shown) of the charging device whether to increase or decrease frequency. The receiver 59 monitors the rectifier output and using Amplitude Modulation (AM), sends packets of information to the transmitter (not shown). A packet is comprised of a preamble, a header, the actual message and a checksum, as defined by the WPC™ standard, and this is interpreted by a microcontroller in the charging device (not shown). The receiver 59 sends a packet by modulating an impedance network. This AM signal reflects back as a change in the voltage amplitude on the transmitter coil. The signal is demodulated and decoded by the transmitter side electronics and the frequency of its coil drive output is adjusted to close the regulation loop. The transmitter (not shown) features internal digital demodulation circuitry. The modulated impedance network on the receiver can either be resistive or capacitive. In the resistive modulation approach, a resistor is periodically added to the load and results in change in resonant curve which causes the amplitude change in the transmitter voltage. In the capacitive modulation approach, a capacitor is periodically added to the load and results in amplitude change in the transmitter voltage.

Similarly communication takes place on the output side through the output inductive coil 75, and the inductive coil of a portable device that is receiving power from the charger. Signals may be transmitted from the portable device's receiver (not shown) to the wireless charger transmitter 73, wherein the receiver (not shown) communicates to the transmitter 73 the quantity of power to send, as well as the frequency to use.

In one embodiment, the USB input connector 56 has a signal connection to a USB controller 74, which controls data flow with a USB port through the USB input. The USB controller 74 may instead be a controller for data from another DC input, like Firewire™ for example. The output connector 65 may also communicate with the USB controller 74, such that a load may transmit data to the USB controller 74. In other embodiments there is no connection between the output connector 65 and the USB controller 74. The USB controller 74 is connected to flash memory 76, which is capable of storing and retrieving data transmitted to and from the USB controller, and the microcontroller 80. The USB controller 74 has a USB port detector 77 that communicates to the microcontroller 80 the current that can be provided by the USB port (not shown). For example, USB 2.0 produces 500 mA while USB 3.0 can deliver a current of 1.5 A. The USB controller 74 is also connected to the microcontroller 80, which determines whether the USB receiving machine is connected to the USB input 56 is a dumb port (i.e. power only port or an auxiliary PV panel) or a smart port, having memory and data transmission capability. In another embodiment the flash memory is a removable memory, such as an SD™ card or microSD™ card. Power from the USB input 56 powers the USB controller 74 as well.

The battery 70 is monitored by a fuel gauge 82, which is able to determine battery conditions, for example, battery voltage, current through battery, battery temperature and battery health, the remaining power, the estimated time remaining at current draw levels. The fuel gauge 82 consists of sensors for determining the battery voltage, current and temperature. The fuel gauge 82 communicates with the microcontroller 80 which receives data from the fuel gauge 82 and makes a determination regarding the condition of the battery 70, and the microcontroller 80 determines which conditions to show on the display 85. For example, in one embodiment the microcontroller 80 calculates the amount of power remaining in the battery relative to a full charge and displays that information.

There are two protection layers for the battery 70. The first protection layer is governed by the battery charger 62 which senses the battery voltage, battery current and battery temperature (there is a temperature probe in the battery that is attached to the charger 62) and protects the battery 70 from over-voltage, over-current and over-temperature conditions, by turning off current from the battery charger 62. Based on the voltage level of the battery 70, the charger decides whether to use a trickle charge, a constant current charge or a constant voltage charge to the battery 70.

The following example assumes a 4.2V battery. The thresholds may be calculated differently for batteries of different voltages. When the battery is lower than 3V, a small current of typically fewer than 200 mA, representing a trickle charge, is used by the charger 62. When the battery voltage is greater than 3V but smaller than 4.2V, the charger 62 uses a constant current charge, providing the highest current that the battery 70 will accept. When the battery voltage is 4.2V, the charger outputs a constant voltage of 4.2V. The internal resistance reduces the battery voltage to slightly less than 4.2V, and the charger 62 provides the current the battery will accept. When the battery is nearly full, the charger 62 will provide a trickle charge current (approximately 5-10% of the battery capacity). In order to effect the appropriate thresholds the battery current is also monitored. The charger 62 has a temperature monitor, and when the battery temperature is out of the normal range, the charger stops charging. The normal charging temperature range is 0° to 45° C.

The microcontroller 80 is the next level of protection, wherein the microcontroller 80 receives signals on the battery's condition from the fuel gauge 82, and is able to monitor the voltage, current and temperature of the battery 70 and turn off or adjust the charge control switch 66 if the battery 70 experiences a voltage, current, or temperature outside a predefined range on charging. The microcontroller 80 acts to protect the battery based on the sensor input from the fuel gauge, and is able to turn off the charger 62 as necessary to protect the battery 70. For example, if the voltage is above 4.2V (for a 4.2V battery) or if the temperature is out of the acceptable range for charging (0°-45° C.), the microcontroller 80 turns the charger 62 off.

On discharging, if the battery voltage is too low (in one embodiment below 3V) then the microcontroller 80 will turn off the charge control switch 66. If an overcurrent signal is raised from fuel gauge 82 during the discharge, the charge control switch 66 is also turned off. If the temperature is out of the acceptable range (in one embodiment −15° to 65° C.) then the microcontroller 80 will turn the charge control switch 66 off.

The DC/DC converter 68 is in communication with the microcontroller 80, which determines the voltage at the battery output and controls the DC/DC converter 68 so as to provide a standard voltage to the power MUX 64. In one embodiment the output of the DC/DC converter 68 is always at 5V, unless it is in overcurrent mode where the power MUX reduces the voltage accordingly (perhaps to 4.7V), so the output current is the maximum the system can provide. This is due to the standardization of input voltages on ports, which is typically 5V. The portable charger is also useful for higher voltage devices such as laptops, where the output voltage may be standardized at a higher value.

The microcontroller 80 is connected with each of the units by serial bus, and is able to communicate with individual units as each has a unique address to identify its signals to the microcontroller 80.

With reference to the circuit diagram in FIG. 2, the PV panel 54 mounted within the case produces a trickle charge which may be sent directly to the battery or output, as described above. In a further embodiment, the charger contains circuitry to maximize the utility of the power received from the PV panel 54, including a DC/DC converter located within the power point controller. While efficient in their recommended operating ranges, the efficiency of DC/DC converters falls off dramatically at low voltages, such that there is a “threshold” to overcome before the DC/DC converter is within its most-efficient operating range. To maximize the power received from the PV panel 54 in view of the DC/DC converter's threshold, the low power output of the PV panel can be stored in a supercapacitor (not shown) first, to collect and rise above the DC/DC converter's threshold voltage. The microcontroller 80 selectively engages the DC/DC converter when the voltage and current of the supercapacitor is sufficiently high to overcome the efficiency threshold of the DC/DC converter, and charges the battery 70.

### EXAMPLES

In one embodiment, the battery is 5700 mAh. An empty battery can be charged within 8 hours by means of the AC power input, while charging by USB input takes more than 12 hours. Performance may be enhanced by increasing the AC/DC converter 58 from a 3.5 W to a 7.5 W rating, and to insert a battery charger 62 that is more efficient, for example moving from a linear charger to a switching charger. To illustrate the example, the linear charger, while its input and output current are same (1.0 A), the voltage difference between input voltage (5V) and the output voltage (battery voltage 3-4.2V) will be on the linear charger and wasted as heat. The average charging efficiency is only about 70%. The switching charger has an efficiency of more than 90%, and is able to vary the voltage and current. If the input to the charger is 5V and 1 A, and the battery is at 3V, then 3V and 1.5 A may be provided to the battery 70 by the switching charger, resulting in faster charging than the linear charger.

As an example, in an embodiment where the PV panel is mounted on the case of the charger, and is therefore limited in size to 2″×2″ for example, the PV panel outputs 100-500 mW in bright light, a trickle charge of 50 mA at 4.5V. Where an auxiliary PV panel is used, which may be of any conceivable size, the power output may be in the range of 3-5 W, for a current of 0.6-1 A at 5V.

As another example, in an embodiment where input inductive coil 53 and output inductive coil 75 are mounted beneath bottom housing 12 and top housing 28 respectively, the input inductive coil 53 is connected to the wireless charger receiver 59 and the output inductive coil is connected to the wireless charger transmitter 73. When the system is in power input mode, the charger receiver 59 communicates with external power source and requests 5V, 1.5 A so that receiver 59 can receive about 5 W (5V, 1 A) power to charge battery. The conversion efficiency is about 70-75% for current technologies due to the power loss during wireless power conversion. When the system is in power output mode, the transmitter 73 receives signal from external power receiver about how much power it needs to output, for example, 5V, 1.5 A. It then outputs that much power from battery for external receiver to take. The power conversion efficiency is also about 70-75%.

As another example, in an embodiment where only the output inductive coil 75 is mounted beneath top housing 28, the output inductive coil is connected to the wireless charger transmitter 73. When the transmitter 73 receives signal from external power receiver about how much power it needs to output, for example, 5V, 1.5 A. It then outputs that much power from battery for external receiver to take. The power conversion efficiency is also about 70-75%.

From the foregoing, it will be observed that numerous variations and modifications may be effected without departing from the scope of the invention. It is to be understood that no limitation with respect to the specific apparatus illustrated herein is intended or should be inferred. It is intended to cover all such modifications as fall within the scope of the claims.

1. A portable battery charger, comprising:
a. a housing;
b. an output inductive coil within and adjacent to the housing; and
c. a battery within the housing having a battery voltage and connected to the output inductive coil
wherein the output inductive coil operates at the battery voltage and transmits power from the battery to an external device having a coil.

2. The charger of claim 1, further comprising:
a. an input inductive coil beneath the surface of the housing to receive power from a source, and transmit the power to the battery.

3. The charger of claim 2, wherein the output inductive coil and the input inductive coil are the same coil.

4. The charger of claim 3, further comprising a switch to select output and input functions of the coil.

5. The charger of claim 1, further comprising a wireless charger transmitter connected to the output coil for communicating with the device.

6. The charger of claim 5, wherein the communicating comprises a quantity of power to send, and a transmission frequency.

7. The charger of claim 2, further comprising a wireless charger receiver connected to the input coil for communicating with the source.

8. The charger of claim 7, wherein the communicating comprises a quantity of power to send, and a transmission frequency.

9. The charger of claim 2, wherein both the input coil and output coil operate simultaneously.

10. The charger of claim 1, further comprising a magnet near the coil for aligning the output coil with the device's coil.

11. The charger of claim 1, further comprising an alignment indicator and an alignment sensor, wherein the alignment sensor determines the efficiency of the power transmission and provides information on the alignment of the output coil and the device coil to a user by means of the alignment indicator.

12. The charger of claim 1 wherein the device's input inductive coil and the charger's output inductive coil are aligned and in close proximity for transmitting power through the housing.

13. A method of charging a portable device, comprising the steps of:
a. aligning the input coil of a portable device with an output coil of a charger using magnets positioned near the coils; and
b. inductively charging the device battery without connecting the device to the charger.

14. The method of claim 13, further comprising the step of communicating with the portable device for regulating power transmission.

15. A method of charging a portable device on a charger, comprising the steps of:
a. commencing the inductive charging between devices;
b. determining the efficiency of the charging;
c. comparing the efficiency to a maximum efficiency;
d. providing feedback through an alignment indicator; and
e. adjusting the position of the portable device on the charger.

16. The method of claim 15 further comprising the step of communicating with the portable device for regulating power transmission.
